(19) United States
(12) Patent Application Publication
(10) Pub. No.: US 2010/0194789 A1
(43) Pub. Date: Aug. 5, 2010

(54) PARTIAL IMAGE UPDATE FOR ELECTROPHORETIC DISPLAYS

(76) Inventors: Craig Lin, San Jose, CA (US); Tin Pham, San Jose, CA (US); Manasa Peri, Milpitas, CA (US); Chun-An Wei, Pan-Chiao City (TW); Bryan Hans Chan, San Francisco, CA (US); Andrew Ho, Atherton, CA (US)

Correspondence Address: HOWREY LLP, C/O IP DOCKETING DEPARTMENT, 2941 FAIRVIEW PARK DRIVE, SUITE 200, FALLS CHURCH, VA, 22042-2924, US

(21) Appl. No.: 12/695,830

(22) Filed: Jan. 28, 2010

Related U.S. Application Data
(60) Provisional application No. 61/148,735, filed on Jan. 30, 2009.

(51) Int. Cl. G09G 5/10

(52) U.S. Cl. 345/690

(57) ABSTRACT

The present invention is directed to methods for partial image updates. Such methods provide the display controller the ability to update selected areas of an image that require updating and leave other areas unchanged. The methods also allow for multiple waveforms to be used for specific regions, giving the display the capability of updating each region with its own waveform.

This application claims priority to U.S. Provisional Application No. 61/148,735, filed Jan. 30, 2009; the content of which is incorporated herein by reference in its entirety.

### FIELD OF THE INVENTION

The present invention is directed to methods useful for partial image update of electrophoretic displays.

### BACKGROUND OF THE INVENTION

An electrophoretic display (EPD) is a non-emissive device based on the electrophoresis phenomenon of charged pigment particles suspended in a solvent. The display usually comprises two plates with electrodes placed opposing each other. One of the electrodes is usually transparent. A suspension composed of a colored solvent and charged pigment particles is enclosed between the two plates. When a voltage difference is imposed between the two electrodes, the pigment particles migrate to one side or the other, according to the polarity of the voltage difference. As a result, either the color of the pigment particles or the color of the solvent may be seen at the viewing side.

Previous driving schemes for electrophoretic displays use full image frame updates where a waveform is chosen by a display controller for the entire image frame. This requires all pixels of the display to be refreshed even for those pixels which remain unchanged. For example, if a small section of an image needed to be refreshed with a blanking of the section and then driving to the next image, the entire image would be blanked and refreshed, even if the data remain unchanged for the majority of sections.

In addition, previous driving schemes perform a calculation between the current image and the next image in order to select an appropriate waveform to be used. This comparison utilizes a significant amount of memory and processing cycles in the display controller or processor. The driving schemes also do not allow for multiple waveforms to be used during an image frame update, i.e., each pixel on the image frame uses the same waveform. This limits the capability of the display to a single waveform per image update. For example, a fast black and white waveform may have a faster transition time than a grayscale waveform; but by using the previous driving schemes, if an image has both black/white and grayscale, the slower grayscale waveform would have to be used.

### SUMMARY OF THE INVENTION

The present invention is directed to methods for partial image updates. Such methods provide the display controller the ability to update selected areas of an image that require updating and leave other areas unchanged. The methods also allow for multiple waveforms to be used for specific regions, giving the display the capability of updating each region with its own waveform. The methods of the invention can also reduce the memory required for image updates, especially if only a small percentage of the image is changing. In practice, the methods may be implemented by a uni-polar driving scheme, a bi-polar driving scheme or a combination of both.

More specifically, the partial image update method comprises

a) outputting region definition, region and lookup table assignment, and data for the new image to be displayed from a microcontroller unit to an integrated circuit unit;

b) feeding lookup table information into said integrated circuit unit;

c) sending driving information by said integrated circuit unit to a driver integrated circuit to drive the display device from said first image to said second image.

In one embodiment, the method further comprises outputting the data for the initial image from the microcontroller unit to the integrated circuit unit in step (a).

In one embodiment, the region definition is pre-determined or fixed.

In one embodiment, the region definition is generated real time.

In one embodiment, the lookup table information comprises a lookup table of black/white driving waveforms.

In one embodiment, the lookup table information comprises a lookup table of grayscale driving waveforms.

In one embodiment, the lookup table information comprises a no change waveform.

In one embodiment, the driving information comprises waveforms for individual pixels.

In one embodiment, the waveform is a multiple voltage level driving waveform.

In one embodiment, the multiple voltage level driving waveform comprises 0V, at least two positive voltage levels and at least two negative voltage levels.

In one embodiment, the multiple voltage levels are −15V, −10V, −5V, 0V, +5V, +10V and +15V.

In one embodiment, only pixel electrodes are driven by the multiple voltage level driving waveform. In another embodiment, both common electrode and pixel electrodes are driven by the multiple voltage driving waveform.

In one embodiment, the waveform comprises a positive voltage, 0V and a negative voltage.

In one embodiment, the display device is an electrophoretic display device.

### BRIEF DISCUSSION OF THE DRAWINGS

FIG. 1 illustrates the feature of partial image update.

FIG. 2 shows an example of region definition.

FIG. 3 illustrates assignment of regions to lookup tables.

FIG. 4 shows how each pixel may be assigned to a lookup table.

FIG. 5 is a diagram illustrating how the partial image update is operated.

FIG. 6 shows a typical display cell of an electrophoretic display.

FIGS. 7 and 8 are examples of driving waveforms for partial image updating.

FIG. 9 is a table which shows the possible voltage combinations in a multiple voltage level driving method.

### DETAILED DESCRIPTION OF THE INVENTION

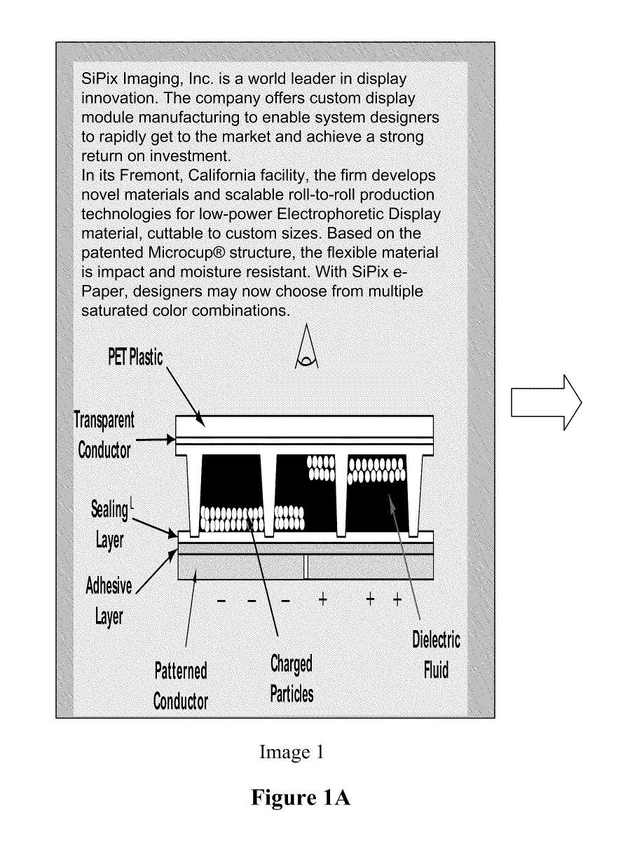

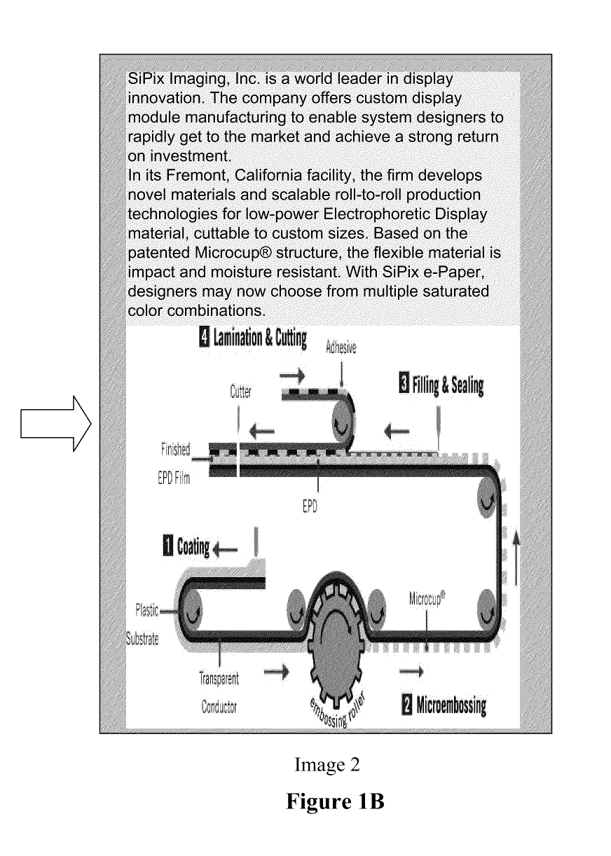

FIG. 1 illustrates the term “partial image update”. As shown, Image 1 is the original image and Image 2 is an updated image. Between the two images, only the drawing at the bottom of the page has changed while other sections remain unchanged.

The present invention is directed to methods which would only update the portions of the image that are changing; but not the remaining portions of the image which would remain unchanged.

In the methods, regions have to be defined first. The regions can be of any size from the entire display screen down to the size of a single pixel. An image may be divided into any number of regions. The regions may also overlap, with a region order of precedence defined. Regions may also be of any shape and in any location on the display screen.

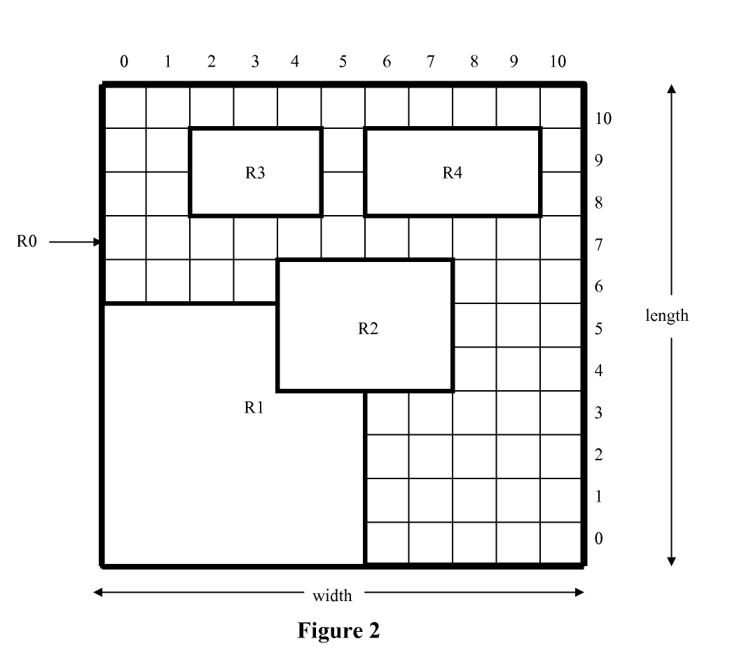

FIG. 2 is an abbreviated version demonstrating the concept of regions. As shown, a display screen has 11×11 pixels and five defined regions (R0, R1, R2, R3 and R4). The entire screen is defined as region R0. Region R1 overlaps with R0 and since R1 is the region defined after R0, R1 has precedence over R0. Similarly, regions R3 and R4 have precedence over R0 and region R2 has precedence over R1 which has precedence over R0.

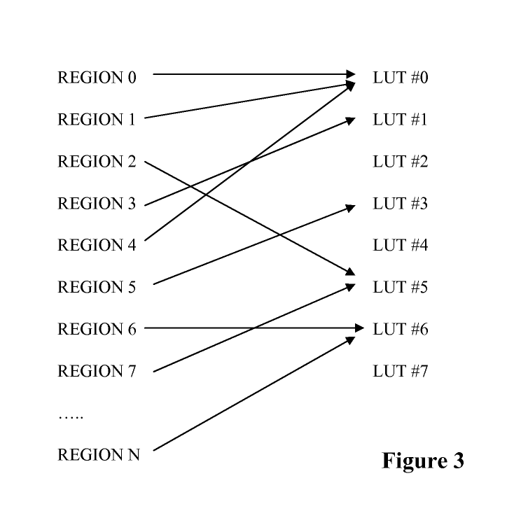

Each region is assigned to a lookup table (LUT), as shown in FIG. 3. The details of the lookup tables are given in a section below. It is noted that more than one region may share one lookup table.

A region, for clarity, may be defined as {location, size, LUT}. The location is the location (x.y) of the starting pixel of the region. The size is the size (width.length) of the region, defined by the pixels. The LUT is the specific LUT assigned to the region. For example regions R0-R4 in FIG. 2 may be expressed as follows:

R0: {0.0, 11.11, LUT#0}

R1: {0.0, 6.6, LUT#0}

R2: {4.4, 4.3, LUT#5}

R3: {2.8, 3.2, LUT#1}

R4: {6.8, 4.2, LUT#0}

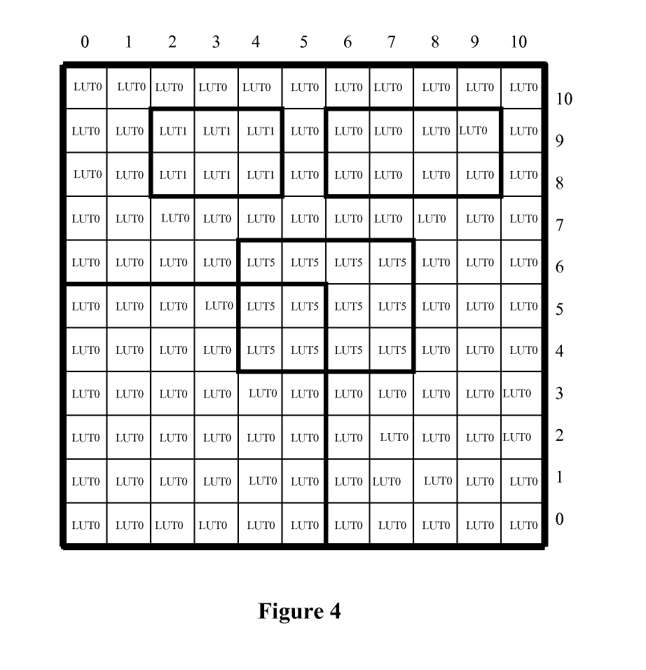

Taking FIGS. 2 and 3 together, each pixel is then associated with a lookup table and is driven accordingly. This is shown in FIG. 4.

As to the lookup tables, there is no limitation on the number of lookup tables a display device may have. The following are a few examples of lookup tables.

There may be a lookup table comprising only black/white driving waveforms. Such a lookup table may have at least four independent driving waveforms to drive pixels from black to black, from black to white, from white to white and from white to black.

There may be a lookup table comprising 16 levels of grayscale. In such a lookup table, there would be 256 independent waveforms to drive pixels from level 0-level 15 to level 0-level 15. In other words, by selecting one of the 256 waveforms, each of levels 0-15 may be driven to level 0, 1, 2, 3, 4, 5, 6, 7, 8, 9, 10, 11, 12, 13, 14 or 15.

There may be a lookup table comprising 8 levels of grayscale. In such a lookup table, there would be 64 independent waveforms to drive pixels from level 0-level 7 to level 0-level 7.

There may also be a lookup table comprising 4 levels of grayscale. In such a lookup table, there would be 16 independent waveforms to drive pixels from level 0-level 3 to level 0-level 3.

There may be a lookup table for “animation” where no bistability feature is required.

There may be a lookup table for typing. In such a lookup table, only the alphabet key(s) which has/have been tapped will undergo an image change.

There may also be a handwriting lookup table. In such a lookup table, only the regions where handwriting is displayed undergo image changes.

There also must be a “no image change” lookup table. When a region undergoes no image changes, that region is assigned to this lookup table.

It is noted that when the uni-polar driving approach is used, the driving waveforms would share the same waveform for the common electrode.

The regions may be pre-determined and fixed. Alternatively, regions may be determined by an algorithm embedded in a microcontroller unit, and in this case the division of the regions may be generated real time.

The region/LUT assignment is not fixed. For example, a region may be initially assigned to one lookup table and reassigned to other lookup tables, as needed. The assignment of regions to lookup tables is a real time function and is dictated by an algorithm also stored in the microcontroller unit.

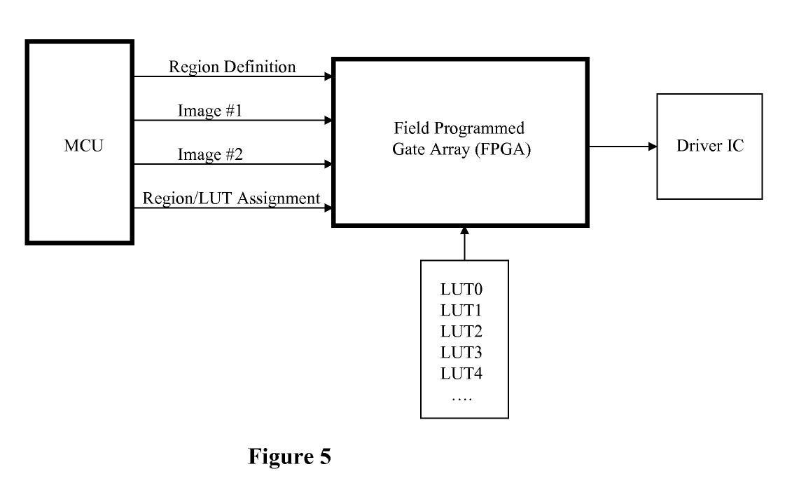

FIG. 5 is a diagram which illustrates how the partial image update of the present invention is operated. The microcontroller unit (MCU) outputs the region definition and the region/LUT assignment along with image #1 (the initial image) and image #2 (the next image to be displayed) to a field programmed gate array (FPGA). The LUT information is also fed into the FPGA.

Alternatively, the initial image (image #1) may be stored in a memory that the FPGA has access to. In this case, the MCU only needs to feed the data for image #2 to the FPGA.

The FPGA processes the information received and sends the driving information (i.e., which waveform is used for which pixel) to driver IC(s) to drive from image #1 to image #2.

While FPGA is used in the diagram, it is understood for the partial image update method of the present invention, the FPGA may be replaced with any customized IC unit.

As stated above, the driving of the pixels may be accomplished by a uni-polar approach, a bipolar approach or a combination of both.

The driving methods currently available, however, pose a restriction on the number of grayscale output. This is due to the fact that display driver ICs and display controllers are limited in speed on the minimum pulse length that a waveform can have. While current active matrix display architectures utilize ICs that can generate pulse lengths down to 8 msec leading to electrophoretic displays which have shortened their response time, even below 150 msec, the grayscale resolution seems to diminish due to the incapability of the system to generate shorter pulse lengths.

To remedy this shortcoming, one lookup table in the present invention may preferably comprise a multiple voltage level driving method. The method comprises applying different voltages selected from multiple voltage levels, to pixel electrodes and optionally also to the common electrodes.

The method allows for multiple voltage levels, specifically, 0 volt, at least two levels of positive voltage and at least two levels of negative voltage.

The method can provide finer control over the driving waveforms and produce a better grayscale resolution.

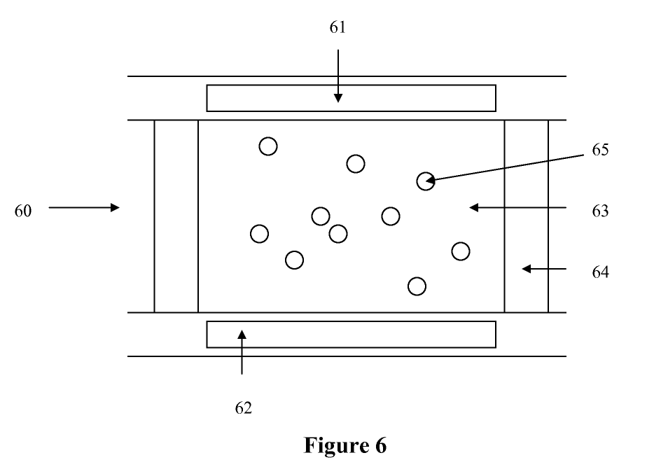

FIG. 6 is used to illustrate a typical display cell (60) of an electrophoretic display. The display cell is sandwiched between a common electrode (61) and a pixel electrode (62). The pixel electrode defines an individual pixel of a multi-pixel electrophoretic display. However, in practice, a plurality of display cells (as a pixel) may be associated with one discrete pixel electrode. The pixel electrode may be segmented in nature rather than pixilated, defining regions of an image to be displayed rather than individual pixels.

An electrophoretic fluid (63) is filled in the display cell. The display cell is surrounded by partition walls (64). In other words, the display cells are separated by the partition walls.

The movement of the charged particles in the display cell is determined by the voltage potential difference applied to the common electrode and the pixel electrode associated with the display cell.

As an example, the charged particles (65) may be positively charged so that they will be drawn to the pixel electrode (62) or the common electrode (61), whichever is at an opposite voltage potential from that of charged particles (65). If the same polarity is applied to the pixel electrode and the common electrode in a display cell, the positively charged pigment particles will then be drawn to the electrode which has a lower voltage potential. Alternatively, the charged pigment particles (65) may be negatively charged.

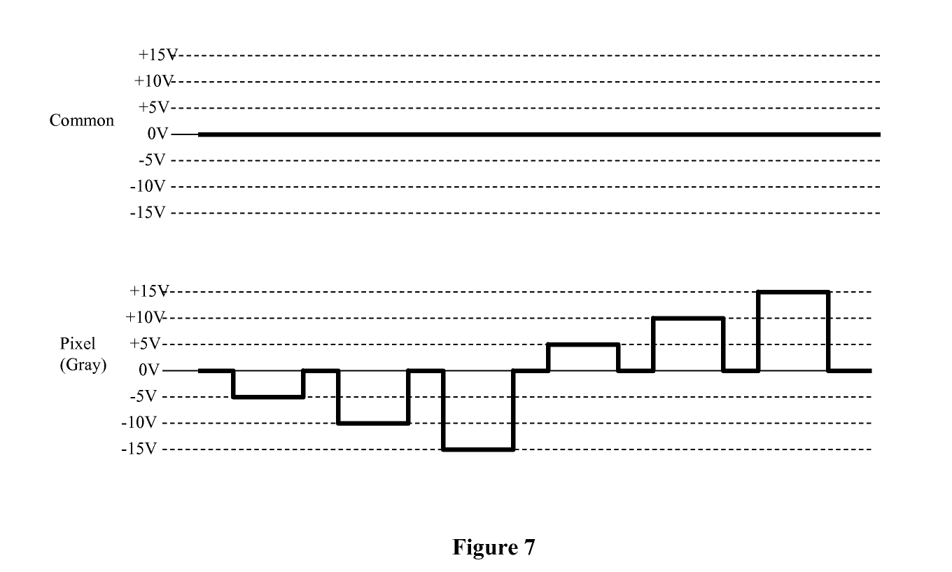

FIG. 7 shows a multiple voltage level driving method. In this example, the voltage applied to the common electrode remains constant at the 0 volt. The voltages applied to the pixel electrode, however, fluctuates between −15V, −10V, −5V, 0V, +5V, +10V and +15V. As a result, the charged particles associated with the pixel electrode would sense a voltage potential of −15V, −10V, −5V, 0V, +5V, +10V or +15V.

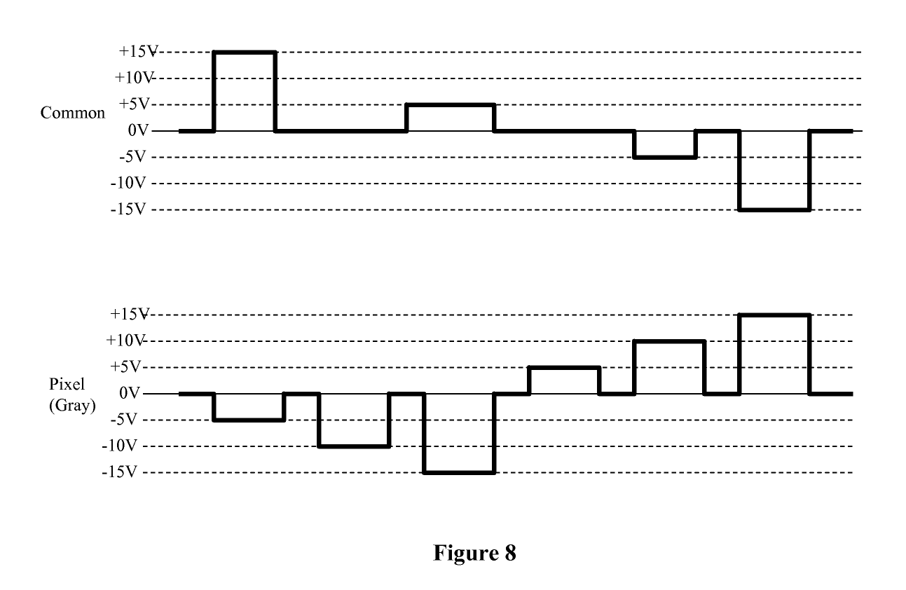

FIG. 8 shows an alternative driving method comprising multiple voltage levels. In this example, the voltage on the common electrode is also modulated.

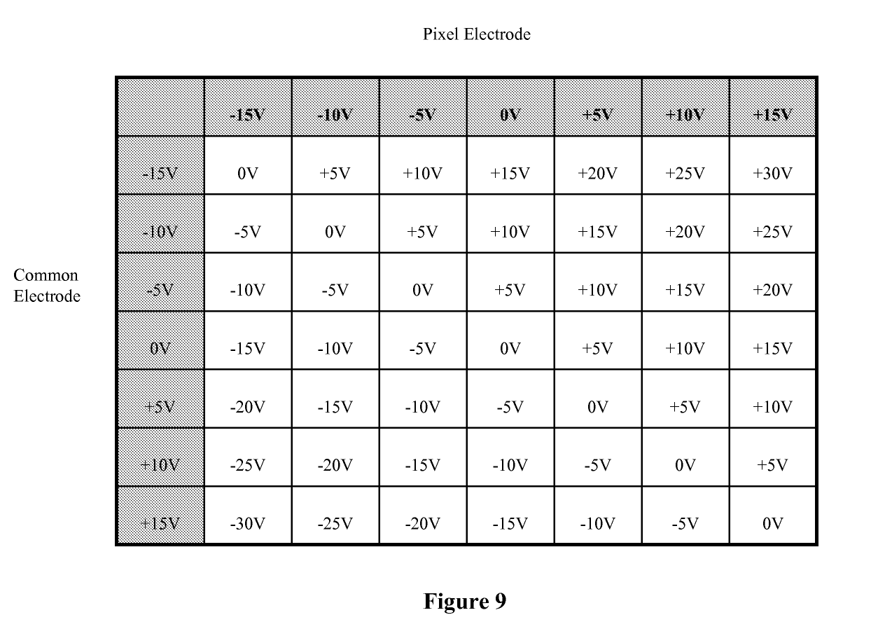

As a result, the charged particles associated with the pixel electrodes will sense even more levels of potential difference, −30V, −25V, −20V, −15V, −10V, −5V, 0V, +5V, +10V, +15V, +20V, +25V and +30V (see FIG. 9). While more levels of potential difference are sensed by the charged particles, more levels of grayscale may be achieved, thus providing a finer resolution of the images displayed.

In one embodiment, the driving waveform may be a standard driving waveform which comprises only three levels of voltage: a positive voltage, 0V and a negative voltage (e.g., +15V, 0V and −15V).

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, materials, compositions, processes, process step or steps, to the objective, spirit and scope of the present invention. All such modifications are intended to be within the scope of the claims appended hereto.

What is claimed is:

1. A partial image update method for a display device, comprising
a) outputting region definition, region and lookup table assignment, and data for the new image to be displayed from a microcontroller unit to an integrated circuit unit;
b) feeding lookup table information into said integrated circuit unit; and
c) sending driving information by said integrated circuit unit to a driver integrated circuit to drive the display device from said first image to said second image.

2. The method of claim 1, further comprising outputting the data for the initial image from the microcontroller unit to the integrated circuit unit in step (a).

3. The method of claim 1, wherein said region definition is pre-determined or fixed.

4. The method of claim 1, wherein said region definition is generated real time.

5. The method of claim 1, wherein said lookup table information comprises a lookup table of black/white driving waveforms.

6. The method of claim 1, wherein said lookup table information comprises a lookup table of grayscale driving waveforms.

7. The method of claim 1, wherein said lookup table information comprises a no change waveform.

8. The method of claim 1, wherein said driving information comprises waveforms for individual pixels.

9. The method of claim 8, wherein said waveform is a multiple voltage level driving waveform.

10. The method of claim 9, wherein said multiple voltage level driving waveform comprises 0V, at least two positive voltage levels and at least two negative voltage levels.

11. The method of claim 10, wherein said multiple voltage levels are −15V, −10V, −5V, 0V, +5V, +10V and +15V.

12. The method of claim 10, wherein only pixel electrodes are driven by the multiple voltage level driving waveform.

13. The method of claim 10, wherein both common electrode and pixel electrodes are driven by the multiple voltage driving waveform.

14. The method of claim 8, wherein said waveform comprises a positive voltage, 0V and a negative voltage.

15. The method of claim 1, wherein said display device is an electrophoretic display device.

16. The method of claim 1, wherein said integrated circuit unit is field programmed gate array.
